(19) United States
(12) Patent Application Publication
(10) Pub. No.: US 2026/0135391 A1
(43) Pub. Date: May 14, 2026

(54) OPTIMIZED RENEWABLE FUEL PRODUCTION USING A MICROGRID CONTROLLER

(71) Applicant: Caterpillar Inc., Peoria, IL (US)

(72) Inventors: Chinmay SHAH, Peoria, IL (US); Sowmya NAGESH, Peoria, IL (US); Gregory Scott HASLER, Pekin, IL (US)

(73) Assignee: Caterpillar Inc., Peoria, IL (US)

(21) Appl. No.: 18/943,076

(22) Filed: Nov. 11, 2024

(51) Int. Cl. H02J 3/38

(52) U.S. Cl. CPC H02J 3/381; H02J 2101/28

(57) ABSTRACT

A microgrid controller may determine, based on load information and energy resource information, that a group of renewable-energy-based (REB) energy resource systems is producing excess renewable energy relative to a load demand on a microgrid; calculate an amount of excess renewable energy produced by the group of REB energy resource systems; transmit, based on the group of REB energy resource systems producing excess renewable energy, a start command, to a balance of plant (BOP) controller, for starting the electrolyzer; transmit, based on receiving a readiness status from the BOP controller indicating that the electrolyzer has successfully started, a communication signal, to the BOP controller, indicating the amount of excess renewable energy for initiating a production of an amount of renewable fuel that is proportional to the amount of excess renewable energy; and dispatch the excess renewable energy to the electrolyzer for producing the renewable fuel.

### TECHNICAL FIELD

The present disclosure relates generally to microgrids and, for example, to a microgrid controller configured to control or manage an operation of a microgrid.

### BACKGROUND

A microgrid is a self-sufficient energy system that serves a particular geographic area, such as a college campus, a hospital complex, a business center, a neighborhood, a mining site, a drilling site, and/or the like. Within a microgrid are one or more kinds of distributed energy resources (DERs) (e.g., solar panels, wind turbines, fuel cells, photovoltaic (PV) cells, generators, energy storage devices (e.g., batteries, capacitors), and/or other energy sources) that produce power for the microgrid. Some microgrids are configured as off-grid electrical power distribution systems (e.g., stand-alone microgrids or islands) that do not connect to a larger electrical power distribution system (e.g., a macrogrid) run by, for example, an electric utility or power plant. Some microgrids are able to operate in a grid-connected mode and in a stand-alone mode. In a grid-connected mode, a microgrid may operate connected to and synchronous with the larger electrical power distribution system. In a stand-alone mode, the microgrid may be disconnected from the larger electrical power distribution system and operate as a stand-alone microgrid. A microgrid controller may control whether the microgrid operates in the grid-connected mode or in the stand-alone mode, for example, based on a schedule or based on one or more conditions being satisfied.

A microgrid may include different types of DERs, including non-renewable-fuel-based DERs (e.g., generator sets and some types of fuel cells), renewable-energy-based DERs (e.g., wind, hydro, and solar), and energy storage systems (ESSs) (e.g., batteries and capacitors). It may be desirable to include, within a microgrid, a fuel generation system that produces a renewable fuel, such as hydrogen. Additionally, it may be desirable to use renewable-energy-based DERs, when excess renewable energy produced by the renewable-energy-based DERs is available, for providing power to the fuel generation system for producing the renewable fuel. Many microgrid systems do not have an efficient way to manage all of the renewable-energy-based DERs to allocate excess renewable energy toward renewable fuel production.

China Patent Application CN102710013A discloses an energy optimizing management system implemented by park energy scheduling and microgrid energy management. The microgrid energy management is in a three-layered structure including a microgrid energy scheduling layer, a microgrid centralized control layer, and a microgrid, stored energy and load local control layer. Constraint conditions of an energy optimizing management method are guaranteed by the microgrid centralized control layer. The output of each microgrid or stored energy is determined by a microgrid and stored energy coordination control policy in a microgrid central controller, and an objective function includes three objective function subsets at different grades. Through computing objective function values at various states by a multi-objective optimizing algorithm based on weight, a defect of randomness and intermittence of the distributed power source can be overcome, the complementary problem among multiple microgrids and multiple micro power sources in the microgrid in the park energy network can be solved, and optimized utilization of clean energy and maximization of system energy efficiency can be achieved. However, the China Patent Application does not disclose use of excess renewable energy for renewable fuel generation.

The microgrid controller of the present disclosure solves one or more of the problems set forth above and/or other problems in the art.

### SUMMARY

In some implementations, a microgrid controller of a microgrid includes a communication interface configured to receive load information corresponding to a plurality of loads connected to the microgrid, receive energy resource information corresponding to a plurality of energy resource systems configured to supply power to the microgrid, communicate with a balance of plant (BOP) controller, and output control signals to the BOP controller for regulating a production of a renewable fuel by an electrolyzer, wherein the plurality of energy resource systems includes a group of renewable-energy-based (REB) energy resource systems configured to generate renewable energy; one or more memories; and one or more processors, communicatively coupled to the one or more memories, configured to: determine, based on the load information and the energy resource information, that the group of REB energy resource systems is producing excess renewable energy relative to a load demand of the plurality of loads, and calculate an amount of excess renewable energy produced by the group of REB energy resource systems, transmit, based on the group of REB energy resource systems producing the excess renewable energy, a start command, to the BOP controller, for starting the electrolyzer, dispatch at least a portion of the excess renewable energy to the electrolyzer for starting the electrolyzer, transmit, based on receiving a readiness status from the BOP controller indicating that the electrolyzer has successfully started, a communication signal, to the BOP controller, indicating the amount of excess renewable energy for initiating a production of an amount of renewable fuel that is proportional to the amount of excess renewable energy, and dispatch the excess renewable energy to the electrolyzer for producing the renewable fuel.

In some implementations, a method for controlling assets of a microgrid includes receiving, by a microgrid controller of a microgrid, load information corresponding to a current load demand of a plurality of loads connected to the microgrid; receiving, by the microgrid controller, energy resource information corresponding to a plurality of energy resource systems configured to supply power to the microgrid, wherein the plurality of energy resource systems includes a group of REB energy resource systems configured to generate renewable energy; determining, by the microgrid controller, based on the load information and the energy resource information, that the group of REB energy resource systems is producing excess renewable energy relative to the current load demand of the plurality of loads; calculating, by the microgrid controller, an amount of excess renewable energy produced by the group of REB energy resource systems; transmitting, by the microgrid controller, based on the group of REB energy resource systems producing the excess renewable energy, a start command to a BOP controller, for starting an electrolyzer that produces a renewable fuel; dispatching, by the microgrid controller, at least a portion of the excess renewable energy to the electrolyzer for starting the electrolyzer; receiving, by the microgrid controller, a readiness status from the BOP controller indicating that the electrolyzer has successfully started; transmitting, by the microgrid controller, based on receiving the readiness status, a communication signal to the BOP controller indicating the amount of excess renewable energy for initiating a production of an amount of renewable fuel that is proportional to the amount of excess renewable energy; and dispatching, by the microgrid controller, the excess renewable energy to the electrolyzer for producing the renewable fuel.

In some implementations, a non-transitory computer-readable medium storing a set of instructions includes one or more instructions that, when executed by one or more processors of a microgrid controller, cause the microgrid controller to: receive load information corresponding to a current load demand of a plurality of loads connected to a microgrid; receive energy resource information corresponding to a plurality of energy resource systems configured to supply power to the microgrid, wherein the plurality of energy resource systems includes a group of REB energy resource systems configured to generate renewable energy; determine, based on the load information and the energy resource information, that the group of REB energy resource systems is producing excess renewable energy relative to the current load demand of the plurality of loads; calculate an amount of excess renewable energy produced by the group of REB energy resource systems; transmit, based on the group of REB energy resource systems producing the excess renewable energy, a start command to a BOP controller, for starting an electrolyzer that produces a renewable fuel; dispatch at least a portion of the excess renewable energy to the electrolyzer for starting the electrolyzer; receive a readiness status from the BOP controller indicating that the electrolyzer has successfully started; transmit, based on receiving the readiness status, a communication signal to the BOP controller indicating the amount of excess renewable energy for initiating a production of an amount of renewable fuel that is proportional to the amount of excess renewable energy; and dispatch the excess renewable energy to the electrolyzer for producing the renewable fuel.

### BRIEF DESCRIPTION OF THE DRAWINGS

FIG. 1 shows a system according to one or more implementations.

FIG. 2 shows a microgrid according to one or more implementations.

FIG. 3 shows a microgrid according to one or more implementations.

FIG. 4 is a flowchart of an example process associated with a microgrid configuration for optimized renewable fuel production .

FIG. 5 is a diagram of example components of the microgrid controller associated with a microgrid configuration for optimized renewable fuel production.

### DETAILED DESCRIPTION

This disclosure relates to a power distribution system and is applicable to any system that distributes and/or receives power via a power grid. Some aspects relate to a microgrid controller that is configured to control one or more components and/or systems associated with the microgrid, including energy resource systems and/or loads. The microgrid controller may control a state of the microgrid based on one or more conditions being satisfied.

A power distribution system, such as a microgrid, may include different types of DERs, including non-renewable-fuel-based DERs (e.g., generator sets, some types of fuel cells, and other fuel-consuming DERs), renewable-energy-based DERs (e.g., wind, hydro, and solar), and energy storage systems (e.g., batteries and capacitors). The power distribution system may also include a renewable fuel production system, such as one or more electrolyzers for generating hydrogen.

Many microgrid systems do not have an efficient way to incorporate a fuel generation system that produces a renewable fuel, such as hydrogen. Moreover, it may be desirable to produce the renewable fuel mostly or entirely from renewable energy sources. However, a microgrid system may need to prioritize a current load demand of other loads (e.g., non-electrolyzer critical site loads) prior to allocating renewable energy to the fuel generation system. For example, it may be desirable to use renewable-energy-based DERs, when excess renewable energy produced by the renewable-energy-based DERs is available, for providing power to the fuel generation system for producing the renewable fuel. Many microgrid systems do not have an efficient way to manage all of the renewable-energy-based DERs to allocate excess renewable energy toward renewable fuel production.

Some implementations described herein provide a microgrid system in which energy generator systems are classified into renewable types (e.g., renewable-energy-based DERs) and non-renewable-fuel-consuming types (e.g., non-renewable-fuel-based DERs). The microgrid system may include a microgrid controller that determines an amount of excess renewable energy available produced by renewable-energy-based DERs after a site load is satisfied, and that allocates the excess renewable energy for renewable fuel generation. The amount of renewable fuel produced may be continuously adjusted based on changes in the amount of excess renewable energy available. The amount of excess renewable energy may be calculated using a scheduler-based load management algorithm.

A fuel generation system may be or include an electrolyzer that is configured to produce a renewable fuel, such as hydrogen. The fuel generation system may be operated by a balance of plant (BOP) controller. The microgrid controller may interact with the BOP controller, while responding to grid conditions and renewable energy availability. For example, the microgrid controller may interact with the BOP controller for initiating safe and autonomous startup/shutdown of the electrolyzer and for managing normal operations of the electrolyzer. Data-analytics-based predictive maintenance of the fuel generation system may be implemented to minimize energy costs and enhance reliability in construction, mining, and industrial operations.

In some implementations, the microgrid controller may use an optimization algorithm to maximize renewable fuel production by managing a dispatch of excess renewable energy generated from the renewable-energy-based DERs. The microgrid controller may calculate the amount of excess renewable energy and direct the excess renewable energy to the fuel generation system (e.g., to the electrolyzer) to produce renewable fuel. The BOP controller may determine an amount of renewable fuel that can be produced based on the amount of excess renewable energy allocated to the fuel generation system. The BOP controller may increase or decrease renewable fuel production based on the amount of excess renewable energy allocated to the fuel generation system. The microgrid controller may consider various factors, such as fuel efficiency, system reliability, electricity pricing, and charge/discharge cycles of energy storage systems, when determining the amount of excess renewable energy that is available from the renewable-energy-based DERs.

In some implementations, the microgrid controller may use the optimization algorithm to determine the amount of excess renewable energy produced by renewable energy sources. The excess renewable energy is extra energy not immediately needed for consumption, which would otherwise go unused.

The BOP controller may manage the fuel generation system (e.g., the electrolyzer). The BOP controller may communicate a readiness status to the microgrid controller, indicating whether the fuel generation system is prepared to start producing renewable fuel. Upon confirming that there is excess renewable energy available and that the fuel generation system is ready, the microgrid controller may send a start command to the BOP controller to start the fuel production process. Based on receiving the start comment, the BOP controller may begin ramping up the fuel generation system in accordance with a manufacturer’s guidelines, to ensure stable and efficient operation of the fuel generation system. After a successful startup, the BOP controller may transmit a status update (e.g., a readiness status) to the microgrid controller.

With all systems checked and the startup of the fuel generation system successful, the microgrid controller may instruct the BOP controller to produce renewable fuel based on the amount of excess renewable energy available, ensuring that the excess renewable energy is effectively converted into renewable fuel.

The microgrid controller may monitor and continuously adjust the amount of excess renewable energy available based on microgrid conditions, such as current load demand, scheduled load demand, the amount of renewable energy being produced by the renewable-energy-based DERs, and/or the charge/discharge cycles of the energy storage systems. The microgrid controller may provide real-time updates to the BOP controller regarding a current amount of excess renewable energy that is available. The BOP controller may continuously adjust a production level of the fuel generation system, in real-time, to match the amount of excess renewable energy available. If more excess renewable energy is available, renewable fuel production may be increased. If less excess renewable energy is available, renewable fuel production may be decreased.

The microgrid controller may continuously monitor an operational status of the fuel generation system and the availability of excess renewable energy. If the microgrid controller determines that there is a lack of excess renewable energy (e.g., the renewable-energy-based DERs are no longer producing enough excess renewable energy to satisfy a current load demand of non-electrolyzer site loads), the microgrid controller may instruct the BOP controller to place the fuel generation system into a standby mode or to shut down the fuel generation system. If the lack of excess renewable energy is temporary, the microgrid controller may instruct the BOP controller to place the fuel generation system into the standby mode and remain ready to resume renewable fuel production when excess renewable energy becomes available again. However, if a significant fault is detected, if the fuel generation system needs maintenance, or if no excess renewable energy availability is forecasted within a predetermined threshold time interval, the microgrid controller may instruct the BOP controller to perform a full shutdown of the fuel generation system.

If there is insufficient excess renewable energy, the microgrid controller may transmit a shutdown command or stop command to the BOP controller to gradually reduce fuel production to prevent energy waste and maintain system stability and efficiency.

If a fault is detected by the BOP controller, the microgrid controller may immediately receive a communication from the BOP controller with a request for a safe and controlled shutdown of the fuel generation system to prevent damage to the fuel generation system. Additionally, the microgrid controller may shed renewable energy generation from the microgrid or may redirect excess renewable energy to one or more energy storage systems, if charging is desired.

After successfully ramping down or shutting down, the BOP controller may transmit a status update to the microgrid controller to keep the microgrid controller informed about a current operational state of the fuel generation system.

The microgrid controller may continuously monitor for the return of available excess renewable energy, and may indicate to the BOP controller when renewable excess energy becomes available. The BOP controller may maintain the fuel generation system in standby or shutdown mode while continuously monitoring for a return of excess renewable energy, indicated by the microgrid controller, and the resolution of any faults. Once conditions are favorable, the BOP controller may restart the fuel generation system based on the amount of excess renewable energy that is available.

Accordingly, the microgrid controller may optimize the use of excess renewable energy, converting the excess renewable energy, that would otherwise be wasted, into renewable fuel. This approach not only reduces energy waste but also enhances fuel production efficiency, ensures system reliability, takes advantage of favorable electricity pricing, and optimizes the charge and discharge cycles of energy storage systems.

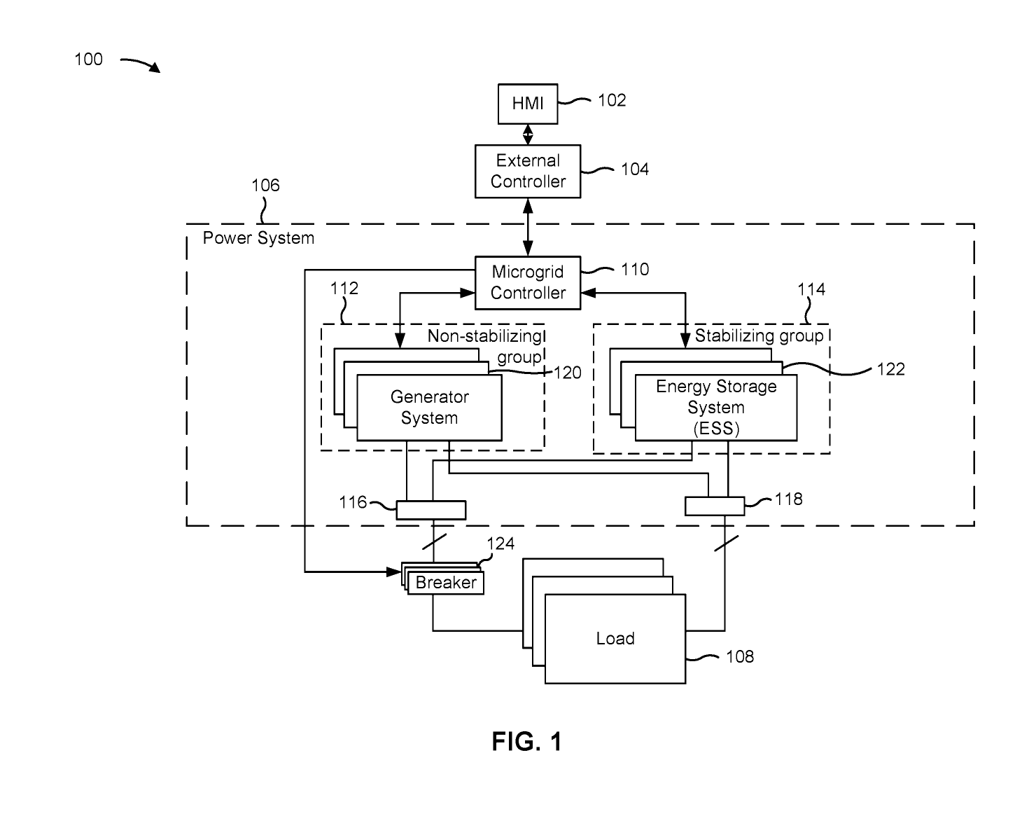

FIG. 1 shows a system 100 according to one or more implementations. The system 100 may include a human-machine interface (HMI) 102, an external controller 104, a power system 106, and one or more loads 108.

The power system 106 may be a microgrid or other type of electrical power distribution system that may provide power to the one or more loads 108. In some cases, the power system 106 may be an off-grid electrical power distribution system. In some cases, the power system 106 may be configurable to operate in a grid-connected mode and in a stand-alone mode. The power system 106 may include a microgrid controller 110, a non-stabilizing group of energy resource systems 112 (e.g., a non-stabilizing group of DERs), a stabilizing group of energy resource systems 114 (e.g., a stabilizing group of DERs), and interfaces 116 and 118. Generally, “off-grid” may mean that the electrical power distribution system is not connected to a larger electrical power distribution system run by, for example, an electric utility or other large-scale electric power generation plant that serves electricity to a geographic area, campus, compound, etc. However, techniques disclosed herein may still be applied to electrical power distribution systems that are connected to larger electrical power distribution systems. For instance, the larger electrical power distribution systems may operate as a power source in a primary provider role or secondary provider role, while the power system 106 may operate as a power source in the other of the primary provider role or secondary provider role.

The non-stabilizing group of energy resource systems 112 may include one or more energy generator systems 120. Each energy generator system 120 may include a power generator (e.g., an engine-generator, a fuel cell, a PV cell, or other power generating system) and a local generator controller communicatively coupled to the microgrid controller 110. Thus, each energy generator system 120 may generate power from a respective power source. Furthermore, the non-stabilizing group of energy resource systems 112 may be further divided into fuel-based (FB) energy resource systems (e.g., non-renewable-fuel-based DERs) and renewable-energy-based (REB) energy resource systems (e.g., renewable-energy-based DERs). Each local generator controller may control how much power a respective power generator generates, control a rate of power distribution, and/or obtain status information corresponding to the respective power generator. Each local generator controller may be controlled by the microgrid controller 110.

The stabilizing group of energy resource systems 114 may include one or more energy storage systems (ESSs) 122. Each energy storage system 122 may include an electric storage device (e.g., one or more batteries and/or capacitors) and a local ESS controller communicatively coupled to the microgrid controller 110. Each local ESS controller may control a flow of power into or out of a respective electric storage device, including charging of the respective electric storage device and discharging of the respective electric storage device, control a rate of power flow, and/or obtain status information corresponding to the respective electric storage device, such as state-of-charge (SOC), state-of-health (SOH), discharge limit, and other device parameters. Each local ESS controller may be controlled by the microgrid controller 110.

The system 100 may also include one or more breakers 124 (e.g., distribution breakers or switches) that may be individually controlled by the microgrid controller 110 to connect a respective load 108 to the power system 106 or disconnect the respective load 108 from the power system 106. The one or more breakers 124 may be part of one or both interfaces 116 and 118.

The HMI 102 may include one or more processors, and may be configured to receive and process one or more inputs from a user, such as an operator. Additionally, the HMI 102 may be configured to provide one or more prompts or outputs to the user. Thus, the HMI 102 may be a user terminal configured to interact with a user to process information and/or commands provided by the user, provide information to the user (e.g., status information), and/or perform one or more tasks or functions in response to processing the information and/or commands provided by the user. The HMI 102 may be communicatively coupled to the external controller 104, which may be communicatively coupled to the microgrid controller 110. In some implementations, the HMI 102 may be communicatively coupled directly to the microgrid controller 110. The external controller 104 may send commands to and receive information from the microgrid controller 110. For example, the external controller 104 may send commands to the microgrid controller 110 based on information received from the HMI 102. Thus, the external controller 104 may be a user-commanded controller. The external controller 104 may be integrated with the HMI 102. The external controller 104 may be a controller of a larger electrical power distribution system (e.g., a macrogrid, a power generation plant, and/or electric utility provider).

The power system 106 may provide electrical power to the one or more loads 108. Generally, the power system 106 may provide alternating current (AC) power at a particular voltage and a particular current. The microgrid controller 110 may control one or more energy storage systems 122 to instantaneously inject power when power is needed by the power system 106 or instantaneously absorb surplus power generated by the power system 106. Accordingly, one of more electric storage devices of the energy storage systems 122 may act as a power consumer on one or more energy generator systems 120 or as a power source for the one or more energy generator systems 120, to thereby ensure that system bus frequencies of the non-stabilizing group of energy resource systems 112 are maintained at a nominal value. In other words, the microgrid controller 110 may control the stabilizing group of energy resource systems 114 to stabilize loads of the non-stabilizing group of energy resource systems 112 in order to maintain the non-stabilizing group of energy resource systems 112 at a relatively constant load, which may reduce a recurrence of frequency deviations from the nominal value.

The microgrid controller 110 may be integrated with, or separate from (but connected to), the interfaces 116 and 118, the energy generator systems 120, and the energy storage systems 122, or combinations thereof. In this manner, a user may, through interaction with the HMI 102, add or remove energy generator systems 120 to increase/reduce system power generation and/or add or remove energy storage systems 122 to increase/reduce system energy storage capacity, in accordance with a user’s preference. For instance, a user may prefer to add additional energy generator systems 120 and/or add additional energy storage systems 122 to increase load capacity if additional loads 108 are expected to be connected to the power system 106, or remove energy generator systems 120 and/or remove energy storage systems 122 to decrease load capacity if loads 108 are expected to be disconnected from the power system 106. Additionally, the microgrid controller 110 may be configured to add or remove energy generator systems 120 and/or add or remove energy storage systems 122 from the power system 106 based one or more conditions being satisfied. In some cases, the microgrid controller 110 may be configured to add or remove energy generator systems 120 and/or add or remove energy storage systems 122 from the power system 106 based on a schedule.

The one or more loads 108 may be any device that can connect to a power distribution system, such as the power system 106, to receive electrical power. Examples of loads may include heavy machinery (e.g., electric mining machines, haulers, etc.), personal devices, appliances, heating, ventilation, and air conditioning (HVAC) systems, industrial drills, personal residence electrical distribution systems, etc. The loads 108 may include one or more non-stable loads, such as one or more cyclic loads. The loads 108 may include unidirectional loads (e.g., loads that can only receive power from the power system 106), bi-directional loads (e.g., loads that can both receive power from the power system 106 and provide power to the power system 106), charging loads (e.g., loads that include a chargeable electric battery), essential loads (e.g., loads that require uninterrupted service), and/or non-essential loads (e.g., loads that do not require uninterrupted service). Loads may be assigned different priorities based on load type, load classification, and/or operation state or mode.

Generally, the one or more loads 108 may receive the power from the power system 106 and use the power in accordance with the operations of the one or more loads 108. Users of the power system 106 and the one or more loads 108 may connect/disconnect the one or more loads 108 by electrically connecting the one or more loads 108 to the interfaces 116 and 118 of the power system 106. For instance, the interfaces 116 and118 may have AC plugs/sockets to connect the one or more loads 108 in parallel to the one or more energy generator systems 120 and the one or more energy storage systems 122 of the power system 106. One or more loads 108 may include a local load controller that may collect load information and transmit the load information to the microgrid controller 110. Load information may include information indicating a load type, a load classification, and/or an operation state or mode of a load 108. The loads can be active (real) or reactive to allow for a power quality-based approach to scheduling. Load information may include load data of a load, such as maximum load and minimum load. For chargeable loads, load information may include maximum charging load, maximum state of charge, minimum state of charge, current state of charge, and usable discharge energy as a function of the current state of charge. Load information may be received by the microgrid controller 110 via the interfaces 116 and 118, which may include one or more communication interfaces coupled to the microgrid controller 110.

The interfaces 116 and 118 may also have a plurality of generator connections and a plurality of energy store connections. The plurality of generator connections may be hardwired electrical connections and/or AC plugs/sockets to connect the one or more energy generator systems 120 in parallel to the at least one load 108 and the one or more energy storage systems 122. The plurality of energy store connections may be hardwired electrical connections and/or AC plugs/sockets to connect the one or more energy storage systems 122 in parallel to the one or more loads 108 and the one or more energy generator systems 120. For instance, the power system 106 may or may not allow addition/removal of energy generator systems 120 and/or addition/removal of energy storage systems 122. Therefore, depending on a configuration, the interfaces 116 and 118 may include: (1) hardwired electrical connections that connect the at least one energy generator system 120; (2) AC plugs/sockets to connect/disconnect the at least one energy generator system 120; (3) hardwired electrical connections that connect the at least one energy storage system 122; and/or (4) AC plugs/sockets to connect/disconnect the at least one energy storage system 122. The interfaces 116 and 118 may be coupled to a system bus (e.g., a power bus) of the power system 106. The system bus may enable one of more of the energy storage systems 122 to absorb power from one or more energy generator systems 120 and/or one or more loads 108 (e.g., for charging and/or storing power).

The one or more energy generator systems 120 may also include communication interfaces. The communication interfaces of the one or more energy generator systems 120 may enable the one or more energy generator systems 120 to communicate with the microgrid controller 110. For instance, the one or more energy generator systems 120 may be connected to the microgrid controller 110 by wired or wireless communication. The one or more energy generator systems 120 may provide the microgrid controller 110 with generator data (e.g., energy resource information). The generator data, for each of the one or more energy generator systems 120, may include load data and/or generator parameters. The load data may include a current (e.g., instantaneous) load seen by the one or more energy generator systems 120 and/or past load data (if one or more energy generator systems 120 store such data locally). The current load/past load data may include voltage (e.g., in volts) and/or current (e.g., in amperes) measured by one or more sensor components included in an energy generator system 120. The generator parameters may include a generator set maximum threshold value and a generator set minimum threshold value. Alternatively, to reduce transmission bandwidth, the generator data may omit the generator parameters, and the one or more energy generator systems 120 may transmit the generator parameters during an initial configuration process between the one or more energy generator systems 120 and the microgrid controller 110. The generator set maximum threshold value and the generator set minimum threshold value may indicate a maximum power load and a minimum power load, respectively, that a generator of an energy generator system 120 may support.

The one or more energy storage systems 122 may be any energy storage device that can store and output AC power. For instance, the one or more energy storage systems 122 may include at least one electrical-chemical energy storage (e.g., a battery), electrical energy storage (e.g., a capacitor, a supercapacitor, or a superconducting magnetic energy storage), mechanical energy storage (e.g., a fly wheel, a pump system), and/or any combination thereof. The one or more energy storage systems 122 may include inverters (individually or collectively) so that the one or more energy storage systems 122 may operate as a power consumer or a power source. The one or more energy storage systems 122 may also include electronic control mechanisms to control (1) how much load the one or more energy storage systems 122 draw, or (2) how much AC power the one or more energy storage systems 122 output.

The one or more energy storage systems 122 may also include communication interfaces. The communication interfaces of the one or more energy generator systems 120 may enable the one or more energy storage systems 122 to communicate with the microgrid controller 110. For instance, the one or more energy storage systems 122 may be connected to the microgrid controller 110 by wired or wireless communication. The one or more energy storage systems 122 may provide the microgrid controller 110 with energy storage data (e.g., energy resource information) and may receive instructions from the microgrid controller 110.

The energy storage data may include, for each of the at least one energy store, a current energy level (e.g., kilowatt-hours currently stored), total energy storage capacity (e.g., kilowatt-hours of capacity), and/or discharge/charge parameters. The current energy level may be measured by a battery meter of an energy storage. The battery meter may one or combinations of a voltmeter, an amp-hour meter, and/or an impedance-based meter. The discharge/charge parameters may indicate an amount of discharge power and an amount of charge power for a respective energy storage device of the one or more energy storage systems 122. Alternatively, to reduce transmission bandwidth, the energy storage data may omit the discharge/charge parameters, and the one or more energy storage systems 122 may transmit the discharge/charge parameters when the one or more energy storage systems 122 are first connected to the microgrid controller 110.

The one or more energy storage systems 122 may receive requests (e.g., instructions) for the energy storage data to provide the energy storage data and/or continuously provide the energy storage data to the microgrid controller 110. The instructions may include energy storage dispatch (ESD) instructions. An ESD instruction may include an instruction to inject power to a system bus of the power system 106 or absorb power from the system bus of the power system 106. ESD instructions may be provided in control signals (e.g., communication signals that provide the ESD instructions). At least one ESD instruction may be utilized to rapidly stabilize the load, thereby stabilizing the bus frequency of the power system 106 in a time efficient manner, rather than attempting to stabilize the load using the one or more energy generator systems 120 alone. The one or more energy storage systems 122 may control the inverters and the electronic control mechanisms to control (1) quantity of load drawn by the one or more energy storage systems 122, or (2) the amount of AC power output produced by the one or more energy storage systems 122, in accordance with the ESD instructions. Reactive and/or active may be used as a qualifier for loads, where reactive loads may contribute to a stabilization algorithm in addition to the active or real loads.

The microgrid controller 110 may include at least one memory device (e.g., one or more memories) for storing instructions (e.g., program code); at least one processor for executing the instructions from the memory device to perform a set of desired operations; and a communication interface (e.g., coupled to a communication bus) for facilitating the communication between various system components. The instructions may be computer-readable instructions for executing a control application. The communication interface of the microgrid controller 110 may enable the microgrid controller 110 to communicate with the one or more energy generator systems 120 and the one or more energy storage systems 122. The microgrid controller 110, while executing the control application, may receive the generator data and the energy storage data (e.g., energy resource information), process the generator data and the energy storage data to generate one or more ESD instructions, and output the ESD instructions to one or more energy generator systems 120 and/or to one or more energy storage systems 122.

To process the generator data and the energy storage data to generate the ESD instructions, the control application may include a load stabilization function and/or an SOC function. The control application may also include a generator set limit function and/or energy store discharge/charge limit function to generate the ESD instruction. In some cases, the load stabilization function may be activated while the power system 106 is configured in stand-alone mode in order to provide off-grid load stabilization. The microgrid controller 110 may automatically activate or deactivate the aforementioned system functions based on a presence or an absence of system parameters (such as no generator set minimum threshold value being available, etc.) or one or more system conditions being satisfied.

Generally, the load stabilization function may ensure that system bus frequencies of the one or more energy generator systems 120 are maintained at a nominal value by causing an amount of power to be absorbed/injected by the one or more energy storage systems 122. The amount of power may be determined based on a difference from an instantaneous load and a moving average of the load. Meanwhile, the SOC function may ensure that the one or more energy storage systems 122 are charged to a target SOC or a target SOC range such that a SOC of one or more energy storage systems does not drift too low or too high, outside of a desired operating range (e.g., the target SOC range). The target SOC or the target SOC range may enable the at least one energy storage system 122 to provide long term beneficial use to the system 100, such as having a range of operation usable by the power system 106 and/or avoid degradation ranges of the one or more energy storage systems 122.

One or more energy generator systems 120 may include an engine-generator (e.g., a genset) that provides AC power to the power system 106, which may provide the AC power to the at least one load 108. Generally, an engine-generator may be any device that converts motive power (mechanical energy) into electrical power to output the AC power. An engine-generator may be a gas turbine electrical generator. In such gas turbine electrical generators, fast changes in load from the at least one load 108 may cause a system bus frequency to deviate from a nominal value. The system bus frequency may be a frequency of electrical components of the generator. For instance, such gas turbine electrical generators may have isochronous frequency control governors that may try to maintain the system bus frequency to the nominal value in response to changes of the load of the one or more loads 108. Therefore, during a transient load charge (e.g., a load transient), the system bus frequency may change as the load on the engine-generator changes. However, a rate of return of the system bus frequency back to the nominal value is slower than a desired rate due to an inertia of motion of physical components (e.g., a rotor of a stator-rotor) of the engine-generator. The slow rate of return may reduce power quality of the power system 106. The power quality of the power system 106 may be determined based on the voltage, frequency, and waveform of the power output to the one or more loads 108. A high power quality may ensure continuity of service for the one or more loads 108, such that the one or more loads 108 are able to properly function as intended. A low power quality may cause the one or more loads 108 to malfunction, fail prematurely, or not operate at all.

Therefore, avoiding load transients may be beneficial in providing better power quality. However, generally, controlling a load of the one or more loads 108 may not be possible or desirable. Instead, the microgrid controller 110 may control the one or more energy storage systems 122 of the stabilizing group of energy resource systems 114 to act as a power consumer or as an energy source, so that the one or more energy generator systems 120 of the non-stabilizing group of energy resource systems 112 may maintain the system bus frequency at the nominal value, thereby ensuring better power quality.

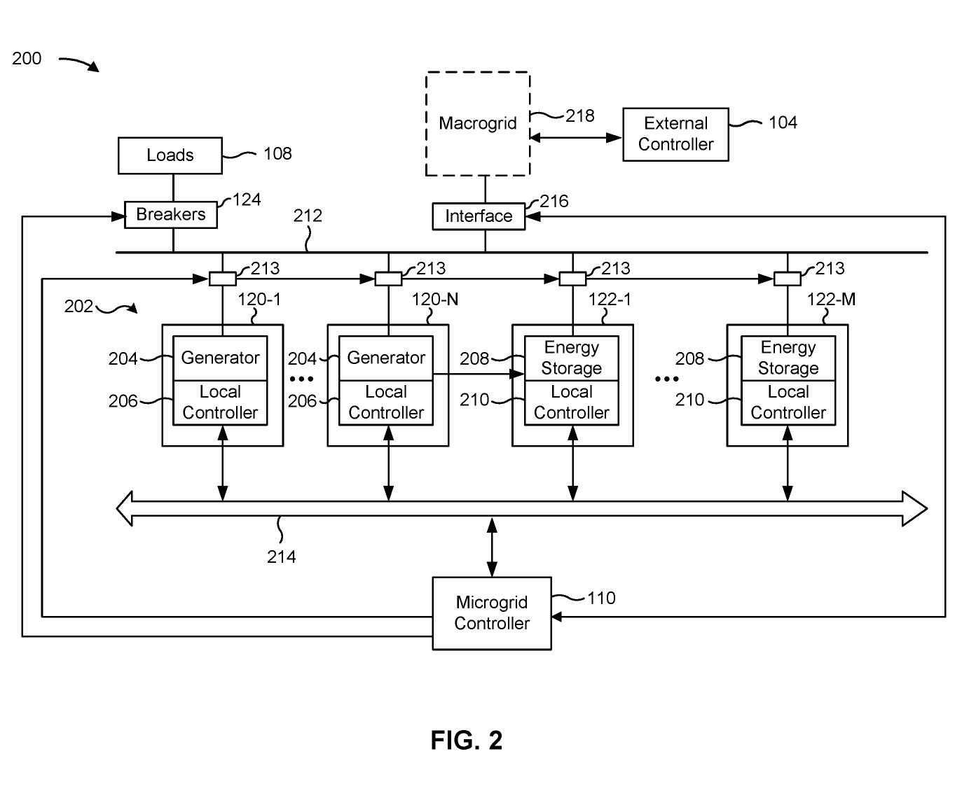

FIG. 2 shows a microgrid 200 according to one or more implementations. The microgrid 200 may be an example of the power system 106 described in connection with FIG. 1. The microgrid 200 may include a plurality of DERs 202. The plurality of DERs 202 may include N energy generator systems 120 and M energy storage systems 122, where N and M are integers greater than zero. For example, the plurality of DERs 202 may include a first energy generator system 120-1 and an N^{th} energy generator system 120-N. Additionally, the plurality of DERs 202 may include a first energy storage system 122-1 and an M^{th} energy storage system 122-M. Each energy generator system 120 may include a power generator 204 and a local generator controller 206. Each energy storage system 122 may include an electric storage device 208 (e.g., one or more batteries and/or capacitors) and a local ESS controller 210.

Each energy generator system 120 may be coupled to a power bus 212 for providing power to one or more loads connected to the power bus 212. Additionally, each energy storage system 122 may be coupled to the power bus 212 for providing power to or absorbing power from the power bus 212 (e.g., for providing power to or absorbing power from one or more components, such as one or more loads and/or one or more energy generator systems 120 connected to the power bus 212).

The microgrid 200 may also include the microgrid controller 110 that is communicatively coupled to the local controllers (e.g., local generator controllers 206 and local ESS controllers 210) of each DER 202 across a communication bus 214. The communication bus 214 may also enable the microgrid 200 to communicate with one or more loads and/or one or more load management systems (e.g., charging systems, fleet management systems, local load controllers, etc.). In some cases, two or more communication buses 214 may be provided. For example, one communication bus may be provided to communicate with local controllers and another communication bus may be provided to communicate with one or more loads and/or one or more load management systems.

Each local generator controller 206 may include any appropriate hardware, software, and/or firmware to sense and control a respective power generator 204, and send information to, and receive information, from microgrid controller 110. For example, a local generator controller 206 may be configured to sense, determine, and/or store generator data of its respective power generator 204. The generator data may be sensed, determined, and/or stored in any conventional manner. Each local generator controller 206 may control whether a respective power generator 204 is connected to or disconnected from the power bus 212 (for example, based on an instruction or a control signal received from the microgrid controller 110).

Each local ESS controller 210 may include any appropriate hardware, software, and/or firmware to sense and control a respective electric storage device 208, and send information to, and receive information, from microgrid controller 110. For example, a local ESS controller 210 may be configured to sense, determine, and/or store various characteristics of its respective electric storage device 208. Such characteristics of the respective electric storage device 208 may include, among others, a current SOC, a current energy, an SOC minimum threshold, an SOC maximum threshold, and a discharge limit of the respective electric storage device 208. These characteristics of each respective electric storage device 208 may be sensed, determined, and/or stored in any conventional manner. Each local ESS controller 210 may control whether a respective electric storage device 208 is connected to or disconnected from the power bus 212 (for example, based on an instruction or a control signal received from the microgrid controller 110).

The microgrid controller 110 may receive or determine a need for charging or discharging of power from the microgrid 200, and may be configured to determine and send signals to allocate a total charge request and/or total discharge request across all of the plurality of DERs 202.

When performing the power allocation functions, the microgrid controller 110 may allocate a certain amount of power from each energy generator system 120 to one or more loads 108. The one or more loads 108 may be connected to the power bus 212 via one or more breakers 124 to receive power from the power bus. When performing the power allocation functions, the microgrid controller 110 may allocate a total charge request and/or a total discharge request across the energy storage systems 122 as a function of a usable energy capacity of each energy storage system 122. The usable energy capacity corresponds to the capacity or amount of energy that an energy storage system 122 can receive in response to a total charging request (usable charge energy), or the capacity or amount of energy that an energy storage system can discharge in response to a total discharge request (usable discharge energy). The usable charge energy is a function of a maximum state of charge, current state of charge, and current energy of the energy storage system, and the usable discharge energy is a function of a minimum state of charge, and current energy of the energy storage system 122. The microgrid controller 110 may determine a usable charge/discharge capacity of each energy storage system 122 (e.g., SOC), a desired charge/discharge of each energy storage system 122, a remainder power of each energy storage system 122, and/or an SOH of each energy storage system 122.

Thus, the microgrid controller 110 regulates a power supply of the microgrid 200 such that an exact amount of desired power flows into or out of the power system 106 at any given time. The microgrid controller 110 may regulate the power supply of the microgrid 200 in cooperation with the local generator controllers 206 and the local ESS controllers 210. The microgrid controller 110 may transmit control signals (e.g., instructions) to the local generator controllers 206 and the local ESS controllers 210 to activate (e.g., to bring online), deactivate (to bring offline), or curtail (limit or regulate to a target output) one or more of the DERs 202. Additionally, or alternatively, the microgrid controller 110 may transmit control signals to one or more switches 213 to control a switch state (e.g., an on state or an off state) of the one or more switches 213, for example, to connect one or more DERs 202 to or disconnect one or more DERs 202 from the microgrid 200 (e.g., the power bus 212). The switches 213 may be integrated in one or both interfaces 116 and 118 described in connection with FIG. 1.

In some cases, two or more power buses 212 may be provided. For example, a power bus may be provided to couple one or more power generators 204 to one or more electric storage devices 208 for charging the one or more electric storage devices 208. For example, the microgrid controller 110 may selectively couple a power generator 204 to an electric storage device 208 to charge the electric storage device 208. Thus, the power bus 212 may be part of a power distribution network of the microgrid 200 that may include one or more power buses used to distribute power between loads 108 and/or DERs 202.

The microgrid 200 may include an interface 216 for connecting the microgrid 200 to and disconnecting the microgrid 200 from an electrical power distribution system 218, such as a macrogrid. The electrical power distribution system 218 may include the external controller 104 (e.g., a macrogrid controller), as described in connection with FIG. 1. The external controller 104 may be coupled to the interface 216 for transmitting control signals, such as instructions or requests, to the microgrid controller 110. The interface 216 may include one or more electrical connections used for connecting the microgrid 200 to the electrical power distribution system 218. The interface 216 may include one or more switches or breakers that are controlled by the microgrid controller 110 for connecting the microgrid 200 to and disconnecting the microgrid 200 from the electrical power distribution system 218. For example, the one or more switches or breakers of the interface 216 may connect the power bus 212 (or another system bus) to or disconnect the power bus 212 (or another system bus) from the electrical power distribution system 218. Thus, the microgrid controller 110 may configure the microgrid 200 to operate in a grid-connected mode by connecting the microgrid 200 to the electrical power distribution system 218 or in a stand-alone mode by disconnecting the microgrid 200 from the electrical power distribution system 218.

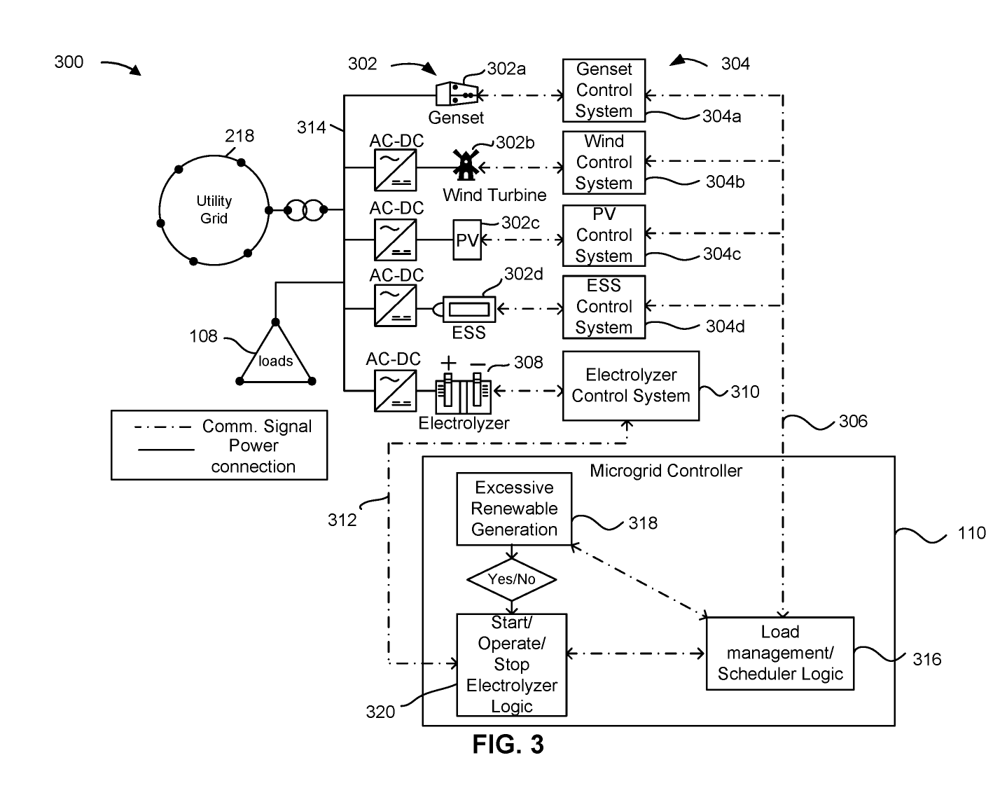

FIG. 3 shows a microgrid 300 according to one or more implementations. The microgrid 300 may be an example of the power system 106 described in connection with FIG. 1 and may be similar to the microgrid 200 described in connection with FIG. 2. The microgrid 300 may include a plurality of energy resource systems 302 that includes a group of FB energy resource systems (e.g., one or more gensets 302a), a group of REB energy resource systems (e.g., one or more wind turbines 302b and one or more PVs 302c), and a group of ESSs (e.g., one or more ESSs 302d) configured to be charged and discharged. Thus, the group of FB energy resource systems may include non-renewable-fuel-based DERs, and the group of REB energy resource systems may include renewable-energy-based DERs, with the group of FB energy resource systems producing fuel-based energy and the group of REB energy resource systems producing renewable energy.

The microgrid 300 may further include a plurality of local controllers 304. Each local controller may control a respective energy resource system. For example, the plurality of local controllers 304 may include a genset local controller 304a, a wind turbine local controller 304b, a PV local controller 304c, and an ESS local controller 304d. The plurality of local controllers 304 may be coupled to the microgrid controller 110 by one or more communication buses 306. The microgrid controller 110 may receive energy resource information from the plurality of local controllers 304 over the one or more communication buses 306. In addition, the one or more communication buses 306 may enable communications between the microgrid controller 110 and the loads 108. For example, the microgrid controller 110 may receive load information from the loads 108 over the one or more communication buses 306. The microgrid controller 110 may use the load information for calculating a current load demand of the loads 108. The microgrid controller 110 may provide control signals, such as start and stop commands, over the one or more communication buses 306 to the plurality of local controllers 304 for controlling an operating state (e.g., an on-state or an off-state) of the plurality of energy resource systems 302.

The microgrid 300 may further include a fuel generation system 308, such as an electrolyzer, that is configured to produce a renewable fuel based on energy provided by the group of REB energy resource systems. A BOP controller 310 may be a local controller for controlling the fuel generation system 308. The BOP controller 310 may interact with the microgrid controller 110 for regulating the operation of the fuel generation system 308 and/or the production of the renewable fuel. The BOP controller 310 may be coupled to the microgrid controller 110 by one or more communication buses 312 for exchanging communications. For example, the BOP controller 310 may provide status information to the microgrid controller 110 associated with an operational status of the fuel generation system 308. In addition, the microgrid controller 110 may provide control signals to the BOP controller 310 for regulating a production of the renewable fuel by the fuel generation system 308.

The plurality of energy resource systems 302 may be coupled to the plurality of loads 108 by one or more power buses 314 for delivering power from the plurality of energy resource systems 302 to the loads 108. In addition, the plurality of energy resource systems 302 may be coupled to the fuel generation system 308 by the one or more power buses 314 for delivering power from the plurality of energy resource systems 302 to the fuel generation system 308. In particular, the group of REB energy resource systems may be coupled to the fuel generation system 308 by the one or more power buses 314 for delivering power to the fuel generation system 308 when excess renewable energy is available. In some implementations, the one or more power buses 314 may be coupled to the electrical power distribution system 218 for exporting power to the electrical power distribution system 218 and/or for importing power from the electrical power distribution system 218.

The microgrid controller 110 may include load management and scheduler logic 316, excess renewable generation logic 318, and electrolyzer communication logic 320. The load management and scheduler logic 316, the excess renewable generation logic 318, and the electrolyzer communication logic 320 may be implemented in one or more processors or processing circuitry, such as a field-programmable gate array.

The load management and scheduler logic 316 may receive load information, energy resource information, and schedule information, determine the current load demand of the loads 108, determine an upcoming (e.g., scheduled) load demand of the loads 108, determine an SOC of each ESS (e.g., ESS 302d), determine how much output power each of the energy resource systems 302 is able to provide, and dispatch output power from the energy resource systems 302 to satisfy the current load and/or any upcoming load demand.

The excess renewable generation logic 318 may determine whether the group of REB energy resource systems is producing excess renewable energy relative to the load demand, and if excess renewable energy is available, calculate an amount of excess renewable energy produced by the group of REB energy resource systems. Whether the group of REB energy resource systems is producing excess renewable energy may also factor in an SOC of each ESS 302d. For example, the load management and scheduler logic 316 may determine that energy from the group of REB energy resource systems may be needed to charge one or more ESSs 302d based on the SOC.

The electrolyzer communication logic 320 may generate communication signals, including commands and/or control signals, for the BOP controller 310. The electrolyzer communication logic 320 may also receive communication signals, including status updates, from the BOP controller 310. Thus, the electrolyzer communication logic 320 may communicate with the BOP controller 310 via the one or more communication buses 312. The electrolyzer communication logic 320 may transmit, based on the group of REB energy resource systems producing the excess renewable energy, a start command, to the BOP controller, for starting the fuel generation system 308. In some examples, the excess renewable generation logic 318 may determine whether the amount of excess renewable energy satisfies a threshold, and indicate to the electrolyzer communication logic 320 to transmit the start command to the BOP controller 310 for starting the fuel generation system 308 based on the amount of excess renewable energy satisfying the threshold. For example, the fuel generation system 308 may require a threshold amount of energy to start or a minimum amount of energy to operate. Thus, the start command may be transmitted if the amount of excess renewable energy satisfies a threshold required to operate the fuel generation system 308. The BOP controller 310 may include a start sequencer for controlling a start sequence of the fuel generation system 308.

The BOP controller 310 may indicate to the electrolyzer communication logic 320 how much power is needed for starting the fuel generation system 308, and the load management and scheduler logic 316 may dispatch at least a portion of the excess renewable energy to the fuel generation system 308 for starting the fuel generation system 308. Once the fuel generation system 308 has successfully started up with no faults, the BOP controller 310 may transmit a readiness status to the electrolyzer communication logic 320. The electrolyzer communication logic 320 may transmit, based on receiving the readiness status from the BOP controller 310 indicating that the fuel generation system 308 has successfully started, a communication signal, to the BOP controller 310, indicating the amount of excess renewable energy for initiating a production of an amount of renewable fuel that is proportional to the amount of excess renewable energy. Additionally, the load management and scheduler logic 316 may dispatch the excess renewable energy from the group of REB energy resource systems to the fuel generation system 308 for producing the renewable fuel.

The excess renewable generation logic 318 may monitor, based on the load information and the energy resource information, the amount of excess renewable energy produced by the group of REB energy resource systems, and update the amount of excess renewable energy to a current amount of excess renewable energy produced by the group of REB energy resource systems. The electrolyzer communication logic 320 may provide, to the BOP controller 310, one or more updates associated with the current amount of excess renewable energy, for regulating the amount of renewable fuel produced by the fuel generation system 308. The load management and scheduler logic 316 may dispatch the current amount of excess renewable energy to the fuel generation system 308 for producing the amount of renewable fuel that is proportional to the current amount of excess renewable energy. The BOP controller 310 may control how much renewable fuel is produced by the fuel generation system 308 based on the current amount of excess renewable energy that is available for use by the fuel generation system 308. For example, the BOP controller 310 may control a speed of a water pump to pump more water or less water into the fuel generation system 308 based on the current amount of excess renewable energy, with the amount of water being proportional to the amount of renewable fuel to be produced.

In some examples, the excess renewable generation logic 318 may update, in real-time, based on the load information and the energy resource information, the amount of excess renewable energy to a current amount of excess renewable energy produced by the group of REB energy resource systems. The electrolyzer communication logic 320 may provide, to the BOP controller 310, in real-time, updates with the current amount of excess renewable energy for regulating the amount of renewable fuel produced by the fuel generation system 308. The load management and scheduler logic 316 may dispatch the current amount of excess renewable energy to the fuel generation system 308 for producing the amount of renewable fuel that is proportional to the current amount of excess renewable energy.

In some examples, the excess renewable generation logic 318 may update, continuously or periodically, based on the load information and the energy resource information, the amount of excess renewable energy to a current amount of excess renewable energy produced by the group of REB energy resource systems. The electrolyzer communication logic 320 may provide, to the BOP controller 310, updates with the current amount of excess renewable energy for regulating the amount of renewable fuel produced by the fuel generation system 308. The load management and scheduler logic 316 may dispatch the current amount of excess renewable energy to the fuel generation system 308 for producing the amount of renewable fuel that is proportional to the current amount of excess renewable energy.

In addition, the excess renewable generation logic 318 may determine that the group of REB energy resource systems are no longer producing excess renewable energy relative to the load demand. Based on the group of REB energy resource systems no longer producing excess renewable energy, the excess renewable generation logic 318 may indicate to the electrolyzer communication logic 320 to transmit a stop command to the BOP controller 310 for shutting down the fuel generation system 308. In some examples, the excess renewable generation logic 318 may determine that the amount of excess renewable energy no longer satisfies a threshold, and may indicate to the electrolyzer communication logic 320 to transmit the stop command to the BOP controller 310 for shutting down the fuel generation system 308 based on the amount of excess renewable energy not satisfying the threshold. The BOP controller 310 may include a stop sequencer for controlling a stop sequence of the fuel generation system 308.

The load management and scheduler logic 316 may monitor, based on the load information and the energy resource information, the amount of excess renewable energy produced by the group of REB energy resource systems; forecast, based on the load information and the energy resource information, an energy shortage indicating that the group of REB energy resource systems will not produce excess renewable energy relative to the load demand for more than a threshold amount of time; and, based on forecasting the energy shortage, indicate to the electrolyzer communication logic 320 to transmit the stop command to the BOP controller 310 for shutting down the fuel generation system 308. Put another way, the load management and scheduler logic 316 may determine that a duration of the energy shortage is forecasted to exceed the threshold amount of time, and instruct the BOP controller 310 to shut down the fuel generation system 308. If the load management and scheduler logic 316 determines that there is not enough renewable energy to safely shut down the fuel generation system 308, the management and scheduler logic 316 may route power from one or more of the energy resource systems 302 to the fuel generation system 308 to safely shut down the fuel generation system 308.

In addition, the load management and scheduler logic 316 may forecast, based on the load information and the energy resource information, a temporary energy shortage wherein the group of REB energy resource systems will not produce the excess renewable energy relative to the load demand for less than the threshold amount of time, and, based on forecasting the temporary energy shortage, indicate to the electrolyzer communication logic 320 to transmit a standby command to the BOP controller 310 for placing the fuel generation system 308 in a standby operation mode. Put another way, the load management and scheduler logic 316 may determine that a duration of the energy shortage is not forecasted to exceed the threshold amount of time, and instruct the BOP controller 310 to set the fuel generation system 308 in the standby operation mode (e.g., instead of initiating a complete shutdown of the fuel generation system 308). The load management and scheduler logic 316 may forecast the temporary energy shortage based on detecting a lack of excess renewable energy produced by the group of REB energy resource systems relative to the load demand. In addition, the load management and scheduler logic 316 may indicate to the electrolyzer communication logic 320 to transmit, based on the threshold amount of time lapsing, a restart command to the BOP controller 310 for resuming the production of renewable fuel by the fuel generation system 308. Alternatively, the load management and scheduler logic 316 or the excess renewable generation logic 318 may indicate to the electrolyzer communication logic 320 to transmit, based on the amount of excess renewable energy satisfying a threshold, a restart command to the BOP controller 310 for resuming the production of renewable fuel by the fuel generation system 308. For example, the load management and scheduler logic 316 or the excess renewable generation logic 318 may instruct the BOP controller 310 to resume the production of renewable fuel in response to the amount of excess renewable energy satisfying the threshold, without waiting for the threshold amount of time to lapse.

The BOP controller 310 may monitor the fuel generation system 308 for one or more faults, and indicate to the microgrid controller 110 an occurrence of a fault. The BOP controller 310 may also indicate that the fuel generation system 308 is to be shut down based on the presence of the fault. The electrolyzer communication logic 320 may receive a fault indicator from the BOP controller 310, and the load management and scheduler logic 316 may supply a portion of the excess renewable energy to the fuel generation system 308 for a controlled shutdown of the fuel generation system 308. The load management and scheduler logic 316 may shed the group of REB energy resource systems from the microgrid based on the controlled shutdown of the fuel generation system 308 being completed. In an alternative to shedding the group of REB energy resource systems from the microgrid, the load management and scheduler logic 316 may redirect, based on receiving the fault indicator, the excess renewable energy to one or more ESSs 302d connected to the microgrid (e.g., after the fuel generation system 308 has been shut down). For example, the excess renewable energy may be used to charge the one or more ESSs 302d. In an alternative to shedding the group of REB energy resource systems from the microgrid or providing the excess renewable energy to one or more ESSs 302d, the load management and scheduler logic 316 may redirect, based on receiving the fault indicator, the excess renewable energy to the electrical power distribution system 218.

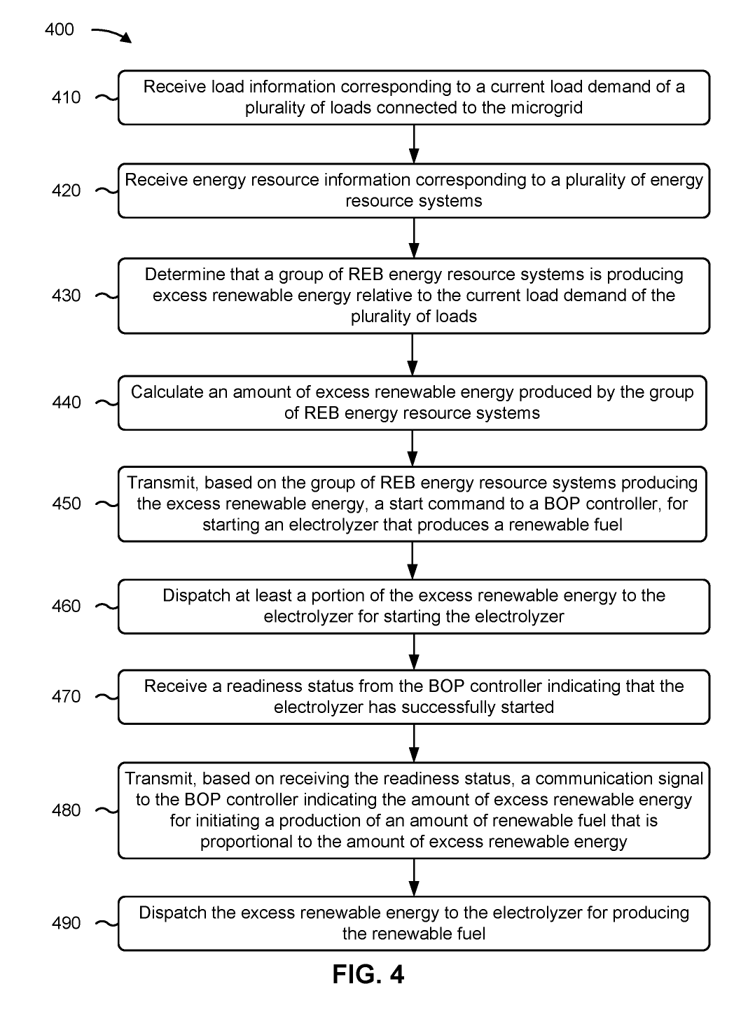

FIG. 4 is a flowchart of an example process 400 associated with a microgrid configuration for optimized renewable fuel production. One or more process blocks of FIG. 4 may be performed by a microgrid controller (e.g., microgrid controller 110). One or more process blocks of FIG. 4 may be performed by the load management and scheduler logic 316, the excess renewable generation logic 318, and/or electrolyzer communication logic 320 of the microgrid controller 110. Additionally, or alternatively, one or more process blocks of FIG. 4 may be performed by in conjunction with an operation of another device or a group of devices separate from or including the microgrid controller, such as a BOP controller (e.g., BOP controller 310).

As shown in FIG. 4, process 400 may include receiving load information corresponding to a current load demand of a plurality of loads connected to the microgrid (block 410).

As further shown in FIG. 4, process 400 may include receiving energy resource information corresponding to a plurality of energy resource systems configured to supply power to the microgrid, wherein the plurality of energy resource systems includes a group of REB energy resource systems configured to generate renewable energy (block 420).

As further shown in FIG. 4, process 400 may include determining, based on the load information and the energy resource information, that the group of REB energy resource systems is producing excess renewable energy relative to the current load demand of the plurality of loads (block 430).

As further shown in FIG. 4, process 400 may include calculating an amount of excess renewable energy produced by the group of REB energy resource systems (block 440).

As further shown in FIG. 4, process 400 may include transmitting, based on the group of REB energy resource systems producing the excess renewable energy, a start command to a BOP controller, for starting an electrolyzer that produces a renewable fuel (block 450).

As further shown in FIG. 4, process 400 may include dispatching at least a portion of the excess renewable energy to the electrolyzer for starting the electrolyzer (block 460).

As further shown in FIG. 4, process 400 may include receiving a readiness status from the BOP controller indicating that the electrolyzer has successfully started (block 470).

As further shown in FIG. 4, process 400 may include transmitting, based on receiving the readiness status, a communication signal to the BOP controller indicating the amount of excess renewable energy for initiating a production of an amount of renewable fuel that is proportional to the amount of excess renewable energy (block 480).

As further shown in FIG. 4, process 400 may include dispatching the excess renewable energy to the electrolyzer for producing the renewable fuel (block 490).

In some implementations, process 400 includes monitoring, based on the load information and the energy resource information, the amount of excess renewable energy produced by the group of REB energy resource systems, updating the amount of excess renewable energy to a current amount of excess renewable energy produced by the group of REB energy resource systems, providing, to the BOP controller, one or more updates with the current amount of excess renewable energy for regulating the amount of renewable fuel produced by the electrolyzer, and dispatching the current amount of excess renewable energy to the electrolyzer for producing the amount of renewable fuel that is proportional to the current amount of excess renewable energy.

In some implementations, process 400 includes monitoring, based on the load information and the energy resource information, the amount of excess renewable energy produced by the group of REB energy resource systems, determining, based on the load information and the energy resource information, that the group of REB energy resource systems are no longer producing excess renewable energy relative to the current load demand, and transmitting, based on the group of REB energy resource systems no longer producing excess renewable energy, a stop command to the BOP controller for shutting down the electrolyzer.

Although FIG. 4 shows example blocks of process 400, in some implementations, process 400 may include additional blocks, fewer blocks, different blocks, or differently arranged blocks than those depicted in FIG. 4. Additionally, or alternatively, two or more of the blocks of process 400 may be performed in parallel.

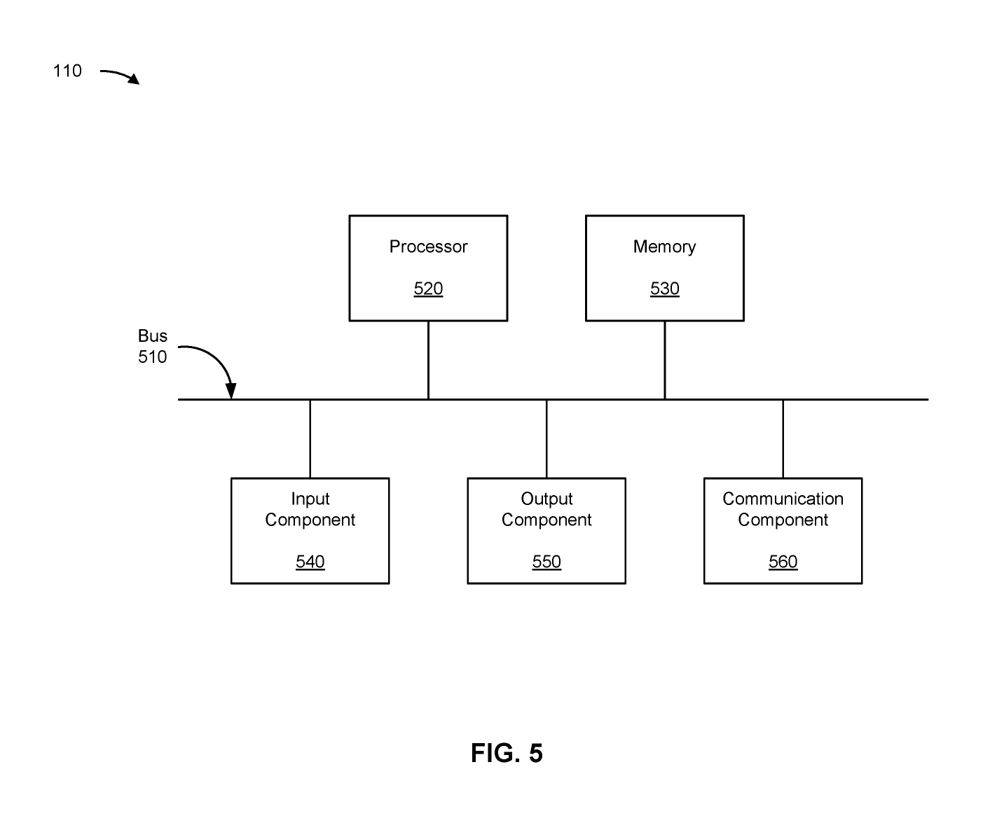

FIG. 5 is a diagram of example components of the microgrid controller 110 associated with a microgrid configuration for optimized renewable fuel production. The microgrid controller 110 may include a bus 510, a processor 520, a memory 530, an input component 540, an output component 550, and/or a communication component 560.

The bus 510 may include one or more components that enable wired and/or wireless communication among the components of the microgrid controller 110. The bus 510 may couple together two or more components of FIG. 5, such as via operative coupling, communicative coupling, electronic coupling, and/or electric coupling. For example, the bus 510 may include an electrical connection (e.g., a wire, a trace, and/or a lead) and/or a wireless bus.

The processor 520 may include a central processing unit, a microprocessor, a controller, a microcontroller, a digital signal processor, a field-programmable gate array, an application-specific integrated circuit, and/or another type of processing component. The processor 520 may be implemented in hardware, firmware, or a combination of hardware and software. The processor 520 may include one or more processors capable of being programmed to perform one or more operations or processes described elsewhere herein. For example, the processor 520 may include the load management and scheduler logic 316, the excess renewable generation logic 318, and/or the electrolyzer communication logic 320. The processor 520 may generate control signals based on an amount of renewable energy produced by a group of REB energy resource systems for controlling a fuel generation system, such as an electrolyzer.

The memory 530 may store information, one or more instructions and/or software (e.g., one or more software applications) related to the operation of the microgrid controller 110. The memory 530 may include one or more memories that are coupled (e.g., communicatively coupled) to one or more processors (e.g., processor 520), such as via the bus 510. Communicative coupling between a processor 520 and a memory 530 may enable the processor 520 to read and/or process information stored in the memory 530 and/or to store information in the memory 530.

The input component 540 may enable the microgrid controller 110 to receive input, load information, generator data, energy storage data, status information, scheduling information, and/or control signals (e.g., control signals from a macrogrid controller). The output component 550 may enable the microgrid controller 110 to provide output, such as one or more control signals for controlling loads, energy storage systems, breakers, switches, and other components associated with the microgrid described herein. The communication component 560 may enable the microgrid controller 110 to communicate with other devices, such as a BOP controller, via a wired connection and/or a wireless connection. For example, the communication component 560 may include a receiver, a transmitter, and/or a transceiver. In some implementations, the communication component 560 may include the electrolyzer communication logic 320.

The microgrid controller 110 may perform one or more operations or processes described herein. For example, a non-transitory computer-readable medium (e.g., memory 530) may store a set of instructions (e.g., one or more instructions or code) for execution by the processor 520. The processor 520 may execute the set of instructions to perform one or more operations or processes described herein. Execution of the set of instructions, by one or more processors 520, may cause the one or more processors 520 and/or the microgrid controller 110 to perform one or more operations or processes described herein. Hardwired circuitry may be used instead of or in combination with the instructions to perform one or more operations or processes described herein. Additionally, or alternatively, the processor 520 may be configured to perform one or more operations or processes described herein. Thus, implementations described herein are not limited to any specific combination of hardware circuitry and software.

### INDUSTRIAL APPLICABILITY

A power distribution system, such as a microgrid, may include different types of DERs, including non-renewable-fuel-based DERs (e.g., generator sets, some types of fuel cells, and other fuel-consuming DERs), renewable-energy-based DERs (e.g., wind, hydro, and solar), and energy storage systems (e.g., batteries and capacitors). A microgrid controller described herein may provide an efficient way to optimize usage of renewable-energy-based DERs to generate renewable fuel, such as hydrogen. The microgrid controller has flexibility to turn on/off an electrolyzer to maximize a usage of renewable-energy-based DERs. For example, the microgrid controller may implement adaptive real-time electrolyzer load balancing based on renewable energy forecasts, grid conditions, electrified equipment demand, and price signals while maximizing battery energy storage and charge-discharge cycle efficiency of the energy storage systems. The microgrid controller may interact with an electrolyzer BOP controller for safe and autonomous startup/shutdown of the electrolyzer, and for regulating operations of the electrolyzer (e.g., during normal running mode) while responding to grid conditions and renewable energy resource availability. Additionally, the microgrid controller may implement data-analytics-based predictive maintenance of the electrolyzer to minimize energy costs and enhance reliability in construction, mining, and industrial operations.

What is claimed is:

1. A microgrid controller, comprising:
a communication interface configured to receive load information corresponding to a plurality of loads connected to a microgrid, receive energy resource information corresponding to a plurality of energy resource systems configured to supply power to the microgrid, communicate with a balance of plant (BOP) controller, and output control signals to the BOP controller for regulating a production of a renewable fuel by an electrolyzer,
wherein the plurality of energy resource systems includes a group of renewable-energy-based (REB) energy resource systems configured to generate renewable energy;
one or more memories; and
one or more processors, communicatively coupled to the one or more memories, configured to:
determine, based on the load information and the energy resource information, that the group of REB energy resource systems is producing excess renewable energy relative to a load demand of the plurality of loads, and calculate an amount of excess renewable energy produced by the group of REB energy resource systems,
transmit, based on the group of REB energy resource systems producing the excess renewable energy, a start command, to the BOP controller, for starting the electrolyzer,
dispatch at least a portion of the excess renewable energy to the electrolyzer for starting the electrolyzer,
transmit, based on receiving a readiness status from the BOP controller indicating that the electrolyzer has successfully started, a communication signal, to the BOP controller, indicating the amount of excess renewable energy for initiating a production of an amount of renewable fuel that is proportional to the amount of excess renewable energy, and
dispatch the excess renewable energy to the electrolyzer for producing the renewable fuel.

2. The microgrid controller of claim 1, wherein the one or more processors are configured to:
monitor, based on the load information and the energy resource information, the amount of excess renewable energy produced by the group of REB energy resource systems, and update the amount of excess renewable energy to a current amount of excess renewable energy produced by the group of REB energy resource systems,
provide, to the BOP controller, one or more updates associated with the current amount of excess renewable energy for regulating the amount of renewable fuel produced by the electrolyzer, and
dispatch the current amount of excess renewable energy to the electrolyzer for producing the amount of renewable fuel that is proportional to the current amount of excess renewable energy.

3. The microgrid controller of claim 1, wherein the one or more processors are configured to:
update, in real-time, based on the load information and the energy resource information, the amount of excess renewable energy to a current amount of excess renewable energy produced by the group of REB energy resource systems,
provide, to the BOP controller, in real-time, updates with the current amount of excess renewable energy for regulating the amount of renewable fuel produced by the electrolyzer, and
dispatch the current amount of excess renewable energy to the electrolyzer for producing the amount of renewable fuel that is proportional to the current amount of excess renewable energy.

4. The microgrid controller of claim 1, wherein the one or more processors are configured to:
update, continuously or periodically, based on the load information and the energy resource information, the amount of excess renewable energy to a current amount of excess renewable energy produced by the group of REB energy resource systems,
provide, to the BOP controller, updates with the current amount of excess renewable energy for regulating the amount of renewable fuel produced by the electrolyzer, and
dispatch the current amount of excess renewable energy to the electrolyzer for producing the amount of renewable fuel that is proportional to the current amount of excess renewable energy.

5. The microgrid controller of claim 1, wherein the one or more processors are configured to:
transmit the start command to the BOP controller for starting the electrolyzer based on the amount of excess renewable energy satisfying a threshold.

6. The microgrid controller of claim 1, wherein the one or more processors are configured to:
monitor, based on the load information and the energy resource information, the amount of excess renewable energy produced by the group of REB energy resource systems,
determine, based on the load information and the energy resource information, that the group of REB energy resource systems are no longer producing excess renewable energy relative to the load demand, and
transmit, based on the group of REB energy resource systems no longer producing excess renewable energy, a stop command to the BOP controller for shutting down the electrolyzer.

7. The microgrid controller of claim 6, wherein the one or more processors are configured to:
transmit the stop command to the BOP controller for shutting down the electrolyzer based on the amount of excess renewable energy not satisfying a threshold.

8. The microgrid controller of claim 1, wherein the one or more processors are configured to:
monitor, based on the load information and the energy resource information, the amount of excess renewable energy produced by the group of REB energy resource systems,
forecast, based on the load information and the energy resource information, an energy shortage indicating that the group of REB energy resource systems will not produce excess renewable energy relative to the load demand for more than a threshold amount of time, and
transmit, based on forecasting the energy shortage, a stop command to the BOP controller for shutting down the electrolyzer.

9. The microgrid controller of claim 1, wherein the one or more processors are configured to:
monitor, based on the load information and the energy resource information, the amount of excess renewable energy produced by the group of REB energy resource systems,
forecast, based on the load information and the energy resource information, a temporary energy shortage that the group of REB energy resource systems will not produce the excess renewable energy relative to the load demand for less than a threshold amount of time, and
transmit, based on forecasting the temporary energy shortage, a standby command to the BOP controller for placing the electrolyzer in a standby operation mode.

10. The microgrid controller of claim 9, wherein the one or more processors are configured to forecast the temporary energy shortage based on detecting a lack of excess renewable energy produced by the group of REB energy resource systems relative to the load demand.

11. The microgrid controller of claim 9, wherein the one or more processors are configured to:
transmit, based on the threshold amount of time lapsing, a restart command to the BOP controller for resuming the production of renewable fuel by the electrolyzer.

12. The microgrid controller of claim 9, wherein the one or more processors are configured to:
transmit, based on the amount of excess renewable energy satisfying a threshold, a restart command to the BOP controller for resuming the production of renewable fuel by the electrolyzer.

13. The microgrid controller of claim 1, wherein the one or more processors are configured to:
receive a fault indicator from the BOP controller, and
supply a portion of the excess renewable energy to the electrolyzer for a controlled shutdown of the electrolyzer.

14. The microgrid controller of claim 13, wherein the one or more processors are configured to:
shed the group of REB energy resource systems from the microgrid based on the controlled shutdown of the electrolyzer being completed.

15. The microgrid controller of claim 13, wherein the one or more processors are configured to:
redirect, based on receiving the fault indicator, the excess renewable energy to one or more energy storage systems connected to the microgrid.

16. The microgrid controller of claim 13, wherein the one or more processors are configured to:
redirect, based on receiving the fault indicator, the excess renewable energy to a macrogrid.

17. A method for controlling assets of a microgrid, comprising:
receiving, by a microgrid controller of a microgrid, load information corresponding to a current load demand of a plurality of loads connected to the microgrid;
receiving, by the microgrid controller, energy resource information corresponding to a plurality of energy resource systems configured to supply power to the microgrid, wherein the plurality of energy resource systems includes a group of renewable-energy-based (REB) energy resource systems configured to generate renewable energy;
determining, by the microgrid controller, based on the load information and the energy resource information, that the group of REB energy resource systems is producing excess renewable energy relative to the current load demand of the plurality of loads;
calculating, by the microgrid controller, an amount of excess renewable energy produced by the group of REB energy resource systems;
transmitting, by the microgrid controller, based on the group of REB energy resource systems producing the excess renewable energy, a start command to a balance of plant (BOP) controller, for starting an electrolyzer that produces a renewable fuel;
dispatching, by the microgrid controller, at least a portion of the excess renewable energy to the electrolyzer for starting the electrolyzer;
receiving, by the microgrid controller, a readiness status from the BOP controller indicating that the electrolyzer has successfully started;
transmitting, by the microgrid controller, based on receiving the readiness status, a communication signal to the BOP controller indicating the amount of excess renewable energy for initiating a production of an amount of renewable fuel that is proportional to the amount of excess renewable energy; and
dispatching, by the microgrid controller, the excess renewable energy to the electrolyzer for producing the renewable fuel.

18. The method of claim 17, further comprising:
monitoring, based on the load information and the energy resource information, the amount of excess renewable energy produced by the group of REB energy resource systems;
updating the amount of excess renewable energy to a current amount of excess renewable energy produced by the group of REB energy resource systems;
providing, to the BOP controller, one or more updates with the current amount of excess renewable energy for regulating the amount of renewable fuel produced by the electrolyzer; and
dispatching the current amount of excess renewable energy to the electrolyzer for producing the amount of renewable fuel that is proportional to the current amount of excess renewable energy.

19. The method of claim 17, further comprising:
monitoring, based on the load information and the energy resource information, the amount of excess renewable energy produced by the group of REB energy resource systems;
determining, based on the load information and the energy resource information, that the group of REB energy resource systems are no longer producing excess renewable energy relative to the current load demand; and
transmitting, based on the group of REB energy resource systems no longer producing excess renewable energy, a stop command to the BOP controller for shutting down the electrolyzer.

20. A non-transitory computer-readable medium storing a set of instructions, the set of instructions comprising:
one or more instructions that, when executed by one or more processors of a microgrid controller, cause the microgrid controller to:
receive load information corresponding to a current load demand of a plurality of loads connected to a microgrid;
receive energy resource information corresponding to a plurality of energy resource systems configured to supply power to the microgrid, wherein the plurality of energy resource systems includes a group of renewable-energy-based (REB) energy resource systems configured to generate renewable energy;
determine, based on the load information and the energy resource information, that the group of REB energy resource systems is producing excess renewable energy relative to the current load demand of the plurality of loads;
calculate an amount of excess renewable energy produced by the group of REB energy resource systems;
transmit, based on the group of REB energy resource systems producing the excess renewable energy, a start command to a balance of plant (BOP) controller, for starting an electrolyzer that produces a renewable fuel;
dispatch at least a portion of the excess renewable energy to the electrolyzer for starting the electrolyzer;
receive a readiness status from the BOP controller indicating that the electrolyzer has successfully started;
transmit, based on receiving the readiness status, a communication signal to the BOP controller indicating the amount of excess renewable energy for initiating a production of an amount of renewable fuel that is proportional to the amount of excess renewable energy; and
dispatch the excess renewable energy to the electrolyzer for producing the renewable fuel.
